(19) United States
(12) Patent Application Publication
(10) Pub. No.: US 2015/0129769 A1
(43) Pub. Date: May 14, 2015

(54) Measurement Method for Object to be Measured

(71) Applicant: MURATA MANUFACTURING CO., LTD., Nagaokakyo-shi (JP)

(72) Inventors: Seiji Kamba, Nagaokakyo-shi (JP); Takashi Kondo, Nagaokakyo-shi (JP); Nobuaki Shirai, Nagaokakyo-shi (JP); Toshiki Okada, Nagaokakyo-shi (JP); Makoto Hasegawa, Nagaokakyo-shi (JP)

(21) Appl. No.: 14/601,284

(22) Filed: Jan. 21, 2015

Related U.S. Application Data
(63) Continuation of application No. PCT/JP2013/069781, filed on Jul. 22, 2013.

(30) Foreign Application Priority Data
Jul. 25, 2012 (JP) 2012-165049

(51) Int. Cl. G01S 17/87

(52) U.S. Cl. CPC G01S 17/87
USPC 250/341.8; 250/341.1

(57) ABSTRACT

A method for measuring the presence or absence of an object to be measured in a specimen or the quantity thereof. The method includes filtrating the object to be measured from the specimen using as a physical filter, a void-arranged structural body having a plurality of void portions penetrating in a direction perpendicular to a primary surface thereof so as to hold the object to be measured by the void-arranged structural body; irradiating an electromagnetic wave on the void-arranged structural body holding the object to be measured; and detecting characteristics of an electromagnetic wave scattered by the void-arranged structural body.

### CROSS REFERENCE TO RELATED APPLICATIONS

The present application is a continuation of International application No. PCT/JP2013/069781, filed Jul. 22, 2013, which claims priority to Japanese Patent Application No. 2012-165049, filed Jul. 25, 2012, the entire contents of each of which are incorporated herein by reference.

### FIELD OF THE INVENTION

The present invention relates to a measurement method for an object to be measured. In more particular, the present invention relates to a measurement method for measuring the presence or absence of an object to be measured or the quantity thereof in which after the object to be measured is held by a void-arranged structural body having void portions, an electromagnetic wave is irradiated on the void-arranged structural body, and the characteristics of an electromagnetic wave scattered thereby are detected.

### BACKGROUND OF THE INVENTION

Heretofore, in order to analyze characteristics of substances, there has been used a measurement method for detecting the presence or absence of an object to be measured or the quantity thereof in which after the object to be measured is held by a void-arranged structural body, an electromagnetic wave is irradiated on the void-arranged structural body holding the object to be measured, and the transmission spectrum or the like of the electromagnetic wave is analyzed. In particular, for example, a method may be mentioned in which after a terahertz wave is irradiated on an object to be measured, such as a protein adhered to a metal mesh filter, the transmission spectrum of the terahertz wave is analyzed.

As a related technique of the transmission spectrum analytical method using an electromagnetic wave as described above, Patent Document 1 has disclosed a measurement method in which toward a void-arranged structural body (in particular, a mesh-shaped conductive plate) having void regions which hold an object to be measured, an electromagnetic wave is irradiated in a direction oblique to the direction perpendicular to a primary surface of the void-arranged structural body, and an electromagnetic wave transmitted therethrough is then measured, so that the characteristics of the object to be measured are detected based on the shift of the position of a dip waveform generated in the measured frequency characteristics, the shift being caused by the presence of the object to be measured.

Heretofore, when an object to be measured contained in a specimen is measured using the measurement method as described above, in general, after the object to be measured is extracted from the specimen, measurement is performed using an electromagnetic wave while the object to be measured thus extracted is held by a void-arranged structural body. Hence, an additional extraction step for the object to be measured is necessary before the measurement is performed, and as a result, there has been a problem in that the number of operation steps for measurement is increased.

In addition, for example, when the object to be measured is filtrated and extracted from a specimen, such as a liquid or a gas, using a membrane filter or the like, a step of, for example, transferring the extracted object to be measured onto the void-arranged structural body is required. However, since it is difficult to transfer all the extracted object to be measured onto the void-arranged structural body, the measurement result has significantly varied in some cases.
Patent Document 1: Japanese Unexamined Patent Application Publication No. 2008-185552

### SUMMARY OF THE INVENTION

In consideration of the above circumstances described above, the present invention aims to provide a measurement method for an object to be measured. The measurement method described above can solve the problems, such as the increase in the number of operation steps and the variation in measurement result, which occur when the object to be measured is necessarily extracted from a specimen, and can measure the object to be measured contained in a specimen with a high accuracy by a simple step.

The present invention provides a measurement method for measuring the presence or absence of an object to be measured in a specimen or the quantity thereof. The method includes a filtration step of filtrating the object to be measured from the specimen using a void-arranged structural body having a plurality of void portions penetrating in a direction perpendicular to a primary surface thereof to hold the object to be measured by the void-arranged structural body.

Next, a measurement step of irradiating an electromagnetic wave on the void-arranged structural body holding the object to be measured to detect the characteristics of an electromagnetic wave scattered by the void-arranged structural body is conducted.

The void portions of the void-arranged structural body preferably have sizes through which the object to be measured is not allowed to pass or is difficult to pass.

The surface of the void-arranged structural body is preferably modified so that the object to be measured is likely to adsorb thereto.

The specimen is preferably a liquid or a gas.

The object to be measured preferably includes microorganisms in a liquid, or an inorganic compound, an organic compound or a composite thereof in a gas.

According to the present invention, since the void-arranged structural body functions as both an extraction filter and a measurement device, the object to be measured contained in the specimen can be measured with a high accuracy by a simple step.

### BRIEF DESCRIPTION OF THE DRAWINGS

FIGS. 1(a) and 1(b) include schematic views each illustrating the structure of a void-arranged structural body used in the present invention.

FIG. 2 is a schematic view illustrating the outline of one example of a measurement step of the present invention.

FIGS. 3(a) and 3(b) are schematic views illustrating an operation method of Example 1, FIG. 3(a) shows a top plan view, and FIG. 3(b) shows a cross-section view.

FIG. 4 is a view showing a SEM photograph of yeasts extracted by the void-arranged structural body in Example 1.

FIG. 5 is a view showing the transmittance characteristics of the void-arranged structural bodies after specimens 1 to 3 are extracted in Example 1.

FIG. 6 is a graph showing the relationship between the number of yeasts on the void-arranged structural body and the transmittance peak thereof in Example 1.

### DETAILED DESCRIPTION OF THE PREFERRED EMBODIMENTS

In the present invention, the measurement of the presence or absence of an object to be measured in a specimen or the quantity thereof indicates the measurement to determine the quantity of a compound which is the object to be measured contained in a specimen, such as a liquid or a gas, and for example, there may be mentioned the case in which the content of a very small amount of the object to be measured in a solution or the like is measured or the case in which the object to be measured is identified. The specimen is preferably a liquid or a gas. In addition, the object to be measured preferably includes microorganisms in a liquid, or an inorganic compound, an organic compound, or a composite thereof in a gas.

The measurement method of the present invention includes:

(1) a filtration step of filtrating an object to be measured from a specimen using a void-arranged structural body having a plurality of void portions penetrating in a direction perpendicular to a primary surface thereof to hold the object to be measured by the void-arranged structural body; and

(2) a measurement step of irradiating an electromagnetic wave on the void-arranged structural body holding the object to be measured to detect the characteristics of an electromagnetic wave scattered by the void-arranged structural body.

(Void-Arranged Structural Body)

The void-arranged structural body used in the present invention has a plurality of void portions penetrating in a direction perpendicular to a primary surface thereof. For example, the plurality of void portions are periodically arranged in at least one direction on the primary surface of the void-arranged structural body. However, all the void portions are not required to be periodically arranged, and as long as the effect of the present invention is not adversely degraded, some void portions may be periodically arranged, and the other void portions may be non-periodically arranged.

The void-arranged structural body is preferably a quasi-periodic structural body or a periodic structural body. The quasi-periodic structural body indicates a structural body which has not the translational symmetry but maintains the order in arrangement. As the quasi-periodic structural body, for example, a Fibonacci structure as a one-dimensional quasi-periodic structural body and a Penrose structure as a two-dimensional quasi-periodic structural body may be mentioned. The periodic structural body indicates a structural body which has a spatial symmetry such as the translational symmetry, and in accordance with the dimension of the symmetry, the structural body is classified into a one-dimensional structural body, a two-dimensional structural body, and a three-dimensional structural body. As the one-dimensional structural body, for example, a wire-grid structure and a one-dimensional diffraction grating may be mentioned. As the two-dimensional periodic structural body, for example, a mesh filter and a two-dimensional diffraction grating may be mentioned. Among the periodic structural bodied mentioned above, the two-dimensional structural body is preferably used.

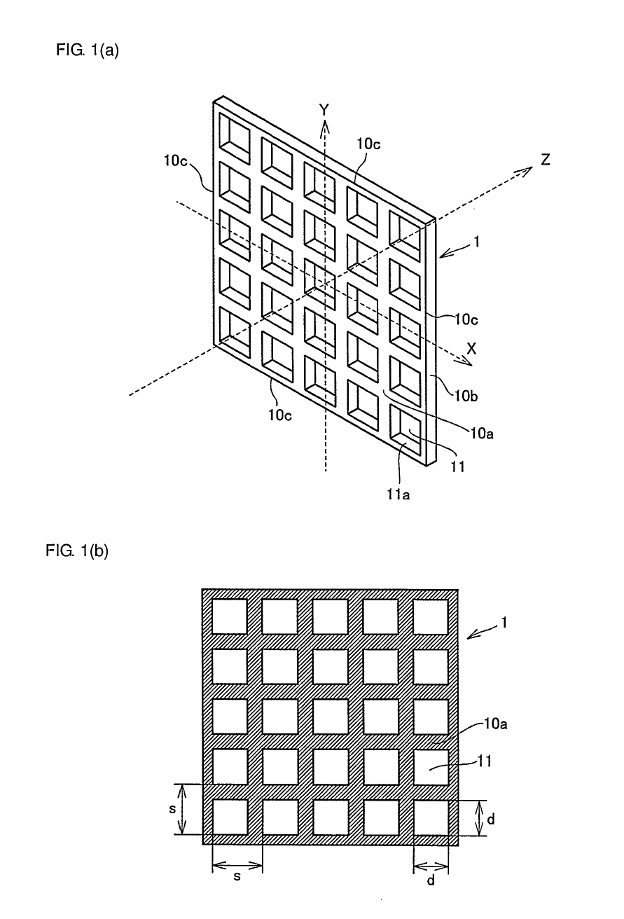

As the two-dimensional periodic structural body, for example, a plate-shaped structural body (lattice-shaped structural body) in which void portions are arranged with predetermined intervals to form a matrix as shown in FIGS. 1(a) and 1(b) may be mentioned. A void-arranged structural body 1 shown in FIG. 1(a) is a plate-shaped structural body in which void portions 11 each having a square shape when viewed from the side of a primary surface 10a of the structural body are provided with identical intervals in two arrangement directions (a longitudinal direction and a lateral direction in the drawing) parallel to the individual sides of the square.

Although the size and arrangement of the void portions of the void-arranged structural body, the thickness thereof, and the like are not particularly limited, the void portion of the void-arranged structural body preferably has a size through which the object to be measured is not allowed to pass or is difficult to pass. In addition, the void-arranged structural body is appropriately designed in accordance with material characteristics of the void-arranged structural body, the frequency of an electromagnetic wave to be used, and the like.

In particular, for example, in the void-arranged structural body 1 in which the void portions are regularly arranged in a longitudinal and a lateral direction as shown in FIG. 1(a), the pore size of the void portion represented by d in FIG. 1(b) is preferably equivalent to or smaller than the size (such as the maximum length of a straight line among straight lines connecting between two points on the surface of the object to be measured) of the object to be measured, and the pore size of the void portion is most preferably approximately the same as the size of the object to be measured. Although a concrete pore size is to be determined in accordance with the size of the object to be measured and is not particularly limited, the pore size is preferably 0.15 to 150 μm and more preferably 0.9 to 9 μm in view of improvement in measurement sensitivity.

In addition, the wavelength of an electromagnetic wave to be used for measurement is preferably set to one tenth to 10 times the pore size as described above. Accordingly, the intensity of the scattered wavelength is further enhanced, and as a result, the signal is more likely to be detected.

For example, in the void-arranged structural body 1 in which the void portions are regularly arranged in a longitudinal and a lateral direction as shown in FIG. 1(a), the lattice spacing (pitch) of the void portion represented by s in FIG. 1(b) is preferably one tenth to 10 times the wavelength of the electromagnetic wave to be used for measurement. By the structure as described above, the scattering is more likely to occur. As a particular lattice spacing, 0.15 to 150 μm is preferable, and in view of improvement in measurement sensitivity, the lattice spacing is more preferably 1.3 to 13 μm.

In addition, the thickness of the void-arranged structural body is preferably 5 times or less the wavelength of the electromagnetic wave to be used for measurement. By the structure as described above, the intensity of the scattered electromagnetic wave is further enhanced, and the signal is likely to be detected.

The total dimension of the void-arranged structural body is not particularly limited and may be determined, for example, in accordance with the area of a beam spot of an electromagnetic wave to be irradiated.

At least a part of the surface of the void-arranged structural body is preferably formed of a conductor. The surface of the void-arranged structural body 1 includes the primary surface 10a, a side surface 10b, and the surface of an inner wall 11a of the void portion shown in FIG. 1(a). In addition, the void-arranged structural body may be entirely formed of a conductor.

In this embodiment, the conductor indicates a substance (material) through which electricity is allowed to pass and includes not only a metal but also a semiconductor. As the metal, for example, a metal capable of bonding to a functional group of a compound having a functional group, such as a hydroxy group, a thiol group, or a carboxy group; a metal having a surface on which a functional group, such as a hydroxy group or an amino group, can be applied; and an alloy thereof may be mentioned. In particular, for example, gold, silver, copper, iron, nickel, chromium, silicon, and germanium may be mentioned; gold, silver copper, nickel, and chromium are preferable; and gold and nickel are more preferable. When gold or nickel is used, if a host molecule particularly has a thiol group (—SH group), it is advantageous since the host molecule can be bonded to the surface of the void-arranged structural body using the thiol group. In addition, when nickel is used, if the host molecule particularly has an alkoxy silane group, it is advantageous since the host molecule can be bonded to the surface of the void-arranged structural body using the alkoxy silane group. In addition, as the semiconductor, for example, a group-IV semiconductor (such as Si or Ge); a compound semiconductor, such as a II-VI-group semiconductor (such as ZnSe, CdS, or ZnO), a III-V-group semiconductor (such as GaAs, InP, or GaN), a IV-group compound semiconductor (such as SiC or SiGe), or a I-III-VI-group semiconductor (such as CuInSe2); or an organic semiconductor may be mentioned.

(1) Filtration Step

In the filtration step of the present invention, since the above void-arranged structural body is used as a filter, the object to be measured is filtrated from the specimen and is held by the void-arranged structural body.

In addition, in order to improve the measurement sensitivity and to perform highly reproducible measurement by suppressing the variation of measurement, the object to be measured is preferably directly adhered to the surface of the void-arranged structural body. For example, a method may be mentioned in which after the object to be measured is filtrated from a liquid specimen using the void-arranged structural body, a wet-state object to be measured remaining, for example, at the void portions of the void-arranged structural body is dried so as to hold the object to be measured by the void-arranged structural body.

In addition, a method for forming a chemical bond or the like directly between the surface of the void-arranged structural body and the object to be measured may also be mentioned. As the chemical bond, for example, a covalent bond (such as a covalent bond between a metal and a thiol group), a van der Waals bond, an ion bond, a metal bond, and a hydrogen bond may be mentioned.

In addition, the surface of the void-arranged structural body is preferably modified so that the object to be measured is likely to adsorb thereto. As the modification by which the object to be measured is likely to adsorb, for example, coating by a material having a high affinity to the object to be measured may be mentioned.

In addition, modification in which host molecules are bonded to the surface of the void-arranged structural body may be performed so that the object to be measured is bonded to the host molecules. In this case, the host molecule is, for example, a molecule which can be bonded specifically to the object to be measured, and as the combination between the host molecule and the object to be measured, for example, combinations between an antigen and an antibody, a sugar chain and a protein, a lipid and a protein, a low molecular compound (ligand) and a protein, a protein and a protein, and a single-strand DNA and a single-strand DNA may be mentioned.

In addition, as a method other than the modification in which the host molecules are bonded, for example, dipping (method in which the structural body is immersed in a liquid and then pulled up therefrom) and deposition (CVD or PVD) may be mentioned.

In addition, the filtration step may be a step performed separately from the measurement step or a step performed sequentially with the measurement step. In particular, for example, after the object to be measured is filtrated from the specimen by the filtration step so as to be held by the void-arranged structural body, the void-arranged structural body holding the object to be measured is moved to the place at which a measurement apparatus is separately installed, and the measurement step may then be performed, or for example, the void-arranged structural body holding the object to be measured is not moved, and the measurement step may be performed by irradiating an electromagnetic wave on the void-arranged structural body in the state as described above.

(2) Measurement Step

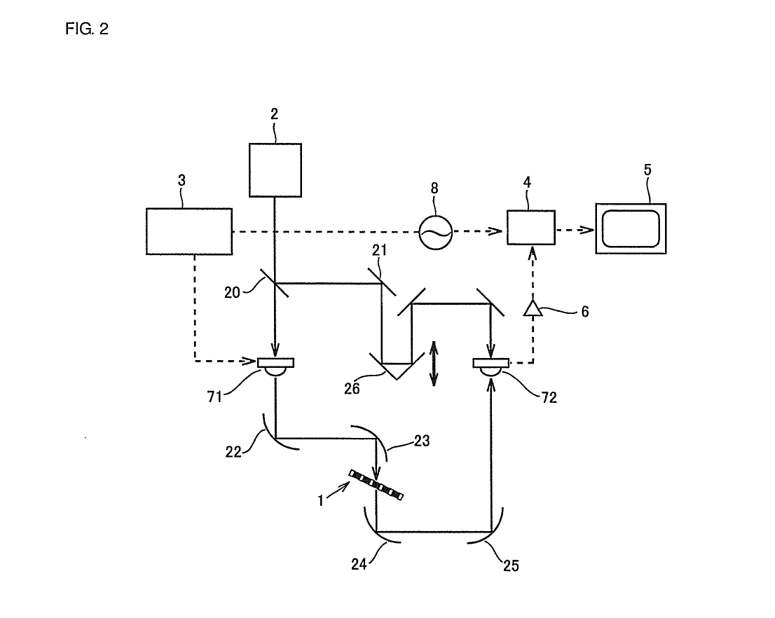

The outline of one example of the measurement step of the present invention will be described with reference to FIG. 2. FIG. 2 is a view schematically showing the entire structure of one example of a measurement apparatus used in the measurement step. This measurement apparatus is an apparatus using an electromagnetic wave (such as a terahertz wave having a frequency of 20 GHz to 120 THz) pulse generated by irradiating laser light emitted from a laser 2 (such as short optical pulse laser) on a semiconductor material.

In the structure shown in FIG. 2, the laser light emitted from the laser 2 is branched into two pathways by a half mirror 20. One branched light is irradiated on an optical conductive element 71 at an electromagnetic wave generation side, and the other branched light is irradiated on an optical conductive element 72 at a receiving side through a time-delay stage 26 by the use of a plurality of mirrors 21 (reference numeral of a mirror having the function similar that thereof is omitted). As the optical conductive elements 71 and 72, there may be used a general optical conductive element in which a dipole antenna having a gap portion in LT-GaAs (low-temperature grown GaAs) is formed. In addition, as the laser 2, a fiber-type laser or a laser using a solid substance such as titanium-sapphire may be used. Furthermore, for the generation and detection of electromagnetic waves, a semiconductor surface may be used without an antenna, or an electro-optic crystal, such as a ZnTe crystal, may be used. In this structure, to the gap portion of the optical conductive element 71 disposed at the generation side, an appropriate bias voltage is applied by a power source 3.

A generated electromagnetic wave is converted into parallel beams by a paraboloidal mirror 22 and is then irradiated on the void-arranged structural body 1 by a paraboloidal mirror 23. A terahertz wave transmitted through the void-arranged structural body 1 is received by the optical conductive element 72 by paraboloidal mirrors 24 and 25. An electromagnetic wave signal received by the optical conductive element 72 is amplified by an amplifier 6 and is then obtained as a time waveform by a lock-in amplifier 4. In addition, after signal processing, such as Fourier transformation, is performed by a PC (personal computer) 5 including calculating means, for example, a transmittance spectrum of the void-arranged structural body 1 is calculated. In order to obtain the time waveform by the lock-in amplifier 4, the bias voltage from the power source 3 applied to the gap of the optical conductive element 71 disposed at the generation side is modulated (amplitude: 5 to 30 V) by a signal of an oscillator 8. Accordingly, synchronous detection is performed, and hence, the S/N ratio can be improved.

The measurement method described above is a method generally called a terahertz time-domain spectroscopy (THz-TDS).

In FIG. 2, the case in which scattering indicates the transmission, that is, the case in which the transmittance of an electromagnetic wave is measured, is shown. The “scattering” in the present invention represents a wide concept including the transmission, which is one form of forward scattering, and the reflection, which is one form of back scattering, and preferably represents the transmission or the reflection. In addition, transmission in the zero-order direction or reflection in the zero-order direction is more preferable.

In addition, in general, when the lattice spacing of a diffraction grating, the incident angle, the diffraction angle, and the wavelength are represented by s, i, θ, and λ, respectively, the spectrum diffracted by the diffraction grating can be represented by the following formula.

s(sin i−sin θ)=nλ. (1)

The zero-order of the above “zero-order direction” indicates the case in which n in the above formula (1) is zero. Since s and λ cannot be zero, n=0 can be satisfied only when sin i-sin θ=0 is satisfied. Hence, the above “zero-order direction” indicates the case in which the incident angle is equal to the diffraction angle, that is, the case in which a travelling direction of an electromagnetic wave is not changed.

The electromagnetic wave used in the present invention is not particular limited as long as capable of generating scattering in accordance with the structure of the void-arranged structural body, and any of electrical waves, infrared rays, visible rays, UV rays, X rays, gamma rays, and the like may by used. In addition, although the frequency thereof is also not particularly limited, the frequency is preferably 1 GHz to 1 PHz, and a terahertz wave having a frequency of 20 GHz to 200 THz is more preferable.

As the electromagnetic wave, for example, a linearly polarized electromagnetic wave (linearly polarized wave) having a predetermined polarized wave direction or a non-polarized electromagnetic wave (non-polarized wave) may be used. As the linearly polarized electromagnetic wave, for example, there may be mentioned a terahertz wave generated by an optical rectification effect of an electro-optical crystal, such as ZnTe, using a short optical pulse laser as a power source, visible light emitted from a semiconductor laser, and an electromagnetic wave emitted from an optical conductive antenna. As the non-polarized electromagnetic wave, for example, infrared rays emitted from a high-pressure mercury lamp and a ceramic lamp may be mentioned. In the measurement step, based on at least one parameter relating to the frequency characteristics of an electromagnetic wave scattered at the void-arranged structural body obtained as described above, the characteristics of the object to be measured are measured. For example, based on the change in dip waveform generated in the frequency characteristics of an electromagnetic wave forward-scattered (transmitted) by the void-arranged structural body 1, or the change in peak waveform generated in the frequency characteristics of an electromagnetic wave back-scattered (reflected) thereby, the change being caused by the presence of the object to be measured, the characteristics of the object to be measured can be measured.

In this embodiment, the dip waveform is a waveform of a valley type (downward convex) portion which is partially observed in frequency characteristics (such as a transmittance spectrum) of the void-arranged structural body in a frequency range in which the ratio (such as the transmittance of an electromagnetic wave) of a detected electromagnetic wave to an irradiated electromagnetic wave is relatively increased. In addition, the peak waveform is a mountain type (upward convex) waveform which is partially observed in frequency characteristics (such as a reflectance spectrum) of the void-arranged structural body in a frequency range in which the ratio (such as the reflectance of an electromagnetic wave) of a detected electromagnetic wave to an irradiated electromagnetic wave is relatively decreased.

According to the measurement method of the present invention, a smaller amount of the object to be measured can be measured by a method simpler than that in the past. In particular, for example, even when the object to be measured is a small amount of microorganisms, such as Escherichia coli, contained in a liquid specimen, after the microorganisms are filtrated and concentrated from the specimen without culturing or the like, the object to be measured can be measured in situ.

In addition, when the measurement method of the present invention is used for detection of entry of dust into a clean room through a gas pipe line or the like, if the void-arranged structural body functioning as both an extraction filter and a measurement device is installed at the pipe line, a highly accurate detection can be easily performed.

### EXAMPLES

Hereinafter, although the present invention will be described in more detail with reference to examples, the present invention is not limited thereto.

### Example 1

In this example, after yeasts were filtrated and extracted from a specimen using a void-arranged structural body, an electromagnetic wave was irradiated on the void-arranged structural body to which the yeasts were adhered, so that the number of yeasts in the specimen was measured. Hereinafter, the procedure will be described in detail.

First, a culture fluid in which yeasts having an average cell diameter of 5 μm were cultured was prepared. After washing of the culture fluid was performed twice with pure water by a centrifugal precipitation method, pure water was added to a precipitate (yeasts) and mixed therewith, so that a yeast suspension was obtained.

After methylene blue staining was performed for the yeast suspension thus obtained to stain dead yeasts, the number of living cells in an aqueous solution was measured by an automatic cell counting device (Cellometer (registered trade name), by Nexcelom Bioscience), and the result was 5×10⁷ [cells/mL].

Specimens 1 to 3 were prepared by dilution of the yeast suspension in which the number of living cells was confirmed at a dilution ratio of (1) 1/10, (2) 1/30, and (3) 1/100.

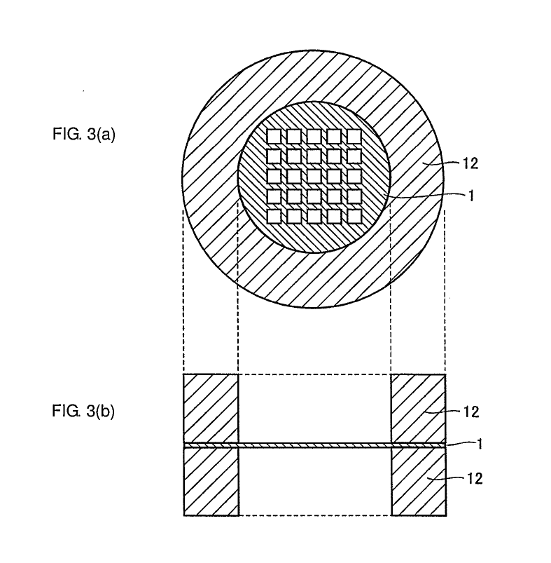

As shown in FIGS. 3(a) and 3(b), as the void-arranged structural body, a Ni-made structural body in which square voids were arranged in a primary surface direction to form a square lattice was prepared, and as the dimensions, the pitch (S in FIG. 3(b)) was 6.5 μm, an opening size (d in FIG. 3(b)) was 4 μm, and the thickness was 1.5 μm. In addition, the entire plate-shaped structural body had a circular shape, and the outside diameter thereof was 6 mm.

Subsequently, in order to easily adsorb the yeasts to the void-arranged structural body, the surface thereof was coated with collagen. In particular, Collagen I (manufactured by BD Japan Co., Ltd.) was dissolved in an acetic acid aqueous solution at a concentration of 0.02 N to form a collagen acetic acid solution at a concentration of 1 [μg/mL], and the void-arranged structural body was immersed in this solution and was left at room temperature for approximately 2 hours. Subsequently, the void-arranged structural body was washed with ultra-pure water and dried, so that a void-arranged structural body provided with collagen adsorbed to the surface thereof was obtained.

As shown in FIG. 3(b), after the void-arranged structural body 1 was sandwiched and fixed between two resin-made jigs 12 each having an outside diameter of 15 mm, 200 μl, of one of the above specimens 1 to 3 was dripped on the exposed portion (see FIG. 3(a)) of the void-arranged structural body 1 by a pipette. After moisture was removed by suction filtration, drying was performed, so that the yeasts in the specimen were filtrated and held by the void-arranged structural body.

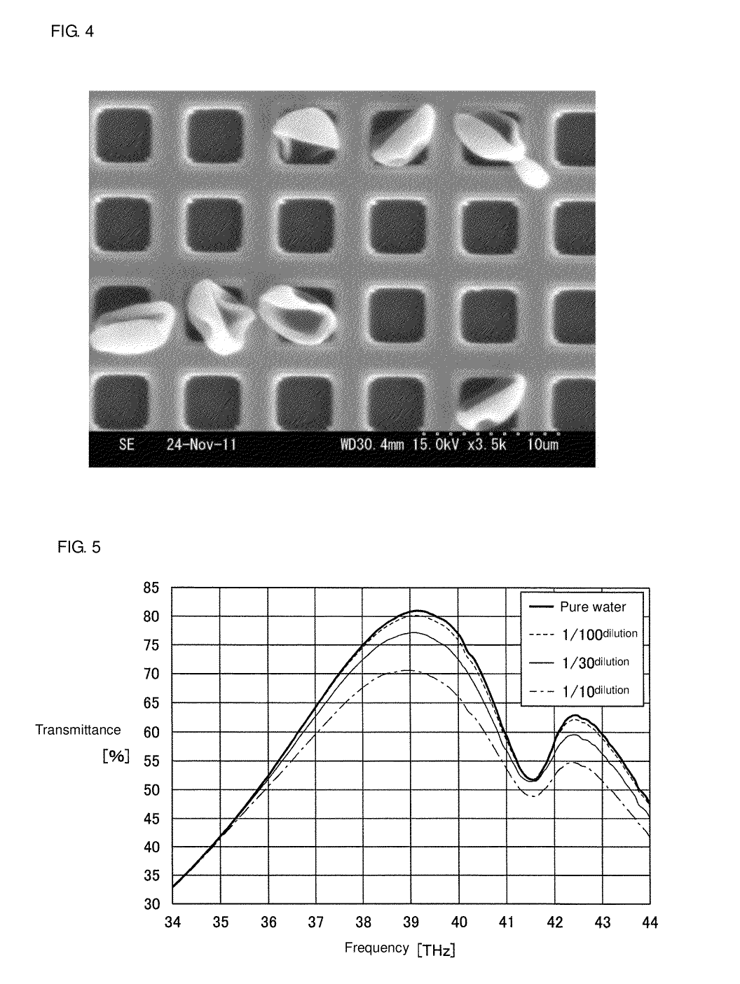

FIG. 4 shows a SEM photograph of yeasts filtrated from the specimen 1 and held by the void portions of the void-arranged structural body. A substance having a shape similar to a collapsed ball shown in FIG. 4 was a yeast, and it was confirmed that sine the void-arranged structural body having an opening of 4 μm square was used for yeasts having an average cell diameter of 5 μm, the filtration of the yeasts and the holding thereof were reliably performed by the void-arranged structural body. In addition, at the corners of the void portion of the void-arranged structural body shown in FIG. 4, projections projecting toward the inside of the void portion were formed.

Next, the transmittance characteristics (transmittance spectra) of the void-arranged structural bodies (samples 1 to 3) obtained after the specimens 1 to 3 were extracted by the above steps were measured. The transmittance spectra thus obtained are shown in FIG. 5. As the control, the result obtained by processing pure water (containing no yeasts) in a manner similar to that described above is also shown. In addition, as a measurement apparatus, spectrum one manufactured by PE Inc. was used, and the measurement was performed using air as reference under the conditions in which the cumulative number of times was 4 times, and the resolution was 4 cm-1.

From the results shown in FIG. 5, it was found that as the number of yeasts extracted by the void-arranged structural body was increased (as the yeast density of the yeast suspension was increased), the transmittance of the void-arranged structural body was decreased.

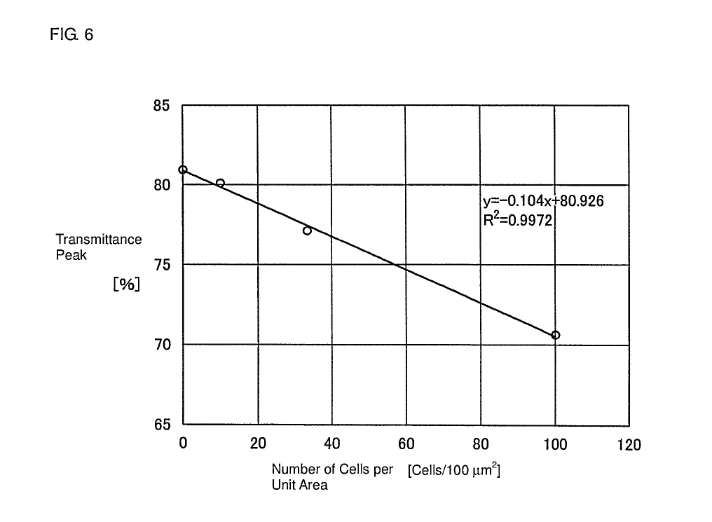

In addition, SEM photographs of yeasts on the void-arranged structural body of each of the samples 1 to 3 were taken at 10 positions, and the number of yeasts per unit area (100 μm²) of each photograph was confirmed by visual inspection. The average value obtained from 10 photographs was regarded as the number of yeasts per unit area on the void-arranged structural body. FIG. 6 is a graph showing the relationship between the number of yeasts on the void-arranged structural body and the transmittance thereof. In FIG. 6, the number of yeasts per unit area (100 μm²) on the void-arranged structural body was plotted along the horizontal axis, and the peak value (transmittance peak) of the transmittance in the transmittance spectrum of each of the samples 1 to 3 shown in FIG. 5 was plotted along the vertical axis.

From the results shown in FIG. 6, it is found that the number of yeasts on the void-arranged structural body and the transmittance peak thereof have a high correlation. From this high correlation described above, it is found that when yeasts are filtrated and extracted by the void-arranged structural body, and the transmission characteristics thereof are measured, the number of yeasts in the specimen can be measured with a high accuracy.

The embodiments and examples disclosed herein are illustrative in all aspects and should not be considered as being limited. The scope of the present invention is not shown by the above description but is shown by the claims and is intended to include all alterations in the claims and the meaning and scope of equivalents.

### REFERENCE SIGNS LIST

1 void-arranged structural body, 10a primary surface, 10b side surface, 10c periphery, 11 void portion, 11a inner wall, 12 resin-made jig, 2 laser, 20 half mirror, 21 mirror, 22, 23, 24, 25 paraboloidal mirror, 26 time-delay stage, 3 power source, 4 lock-in amplifier, 5 PC (personal computer), 6 amplifier, 71, 72 optical electrical conductive element, 8 oscillator

1. A method for measuring, the method comprising:
filtrating an object to be measured from a specimen using a void-arranged structural body having a plurality of void portions penetrating in a direction perpendicular to a primary surface of the void-arranged structural body so as to hold the object to be measured by the void-arranged structural body;
irradiating an electromagnetic wave on the void-arranged structural body holding the object to be measured; and
detecting characteristics of an electromagnetic wave scattered by the void-arranged structural body so as to measure presence or absence of the object to be measured.

2. The method according to claim 1, wherein the plurality of void portions of the void-arranged structural body are sized such that the object to be measured does not pass therethrough.

3. The method according to claim 1, wherein the primary surface of the void-arranged structural body is modified so that the object to be measured is adsorbed thereto.

4. The method according to claim 1, wherein the specimen is a liquid or a gas.

5. The method according to claim 4, wherein the object to be measured includes microorganisms in a liquid, or an inorganic compound, an organic compound or a composite thereof in a gas.

6. The method according to claim 1, wherein at least one parameter relating to frequency characteristics of the electromagnetic wave scattered by the void-arranged structural body is used to measure characteristics of the object to be measured.

7. The method according to claim 6, wherein the at least one parameter is a change in a dip waveform generated in the frequency characteristics of the electromagnetic wave.

8. The method according to claim 7, wherein the electromagnetic wave is a forward-scattered electromagnetic wave.

9. The method according to claim 7, wherein the dip waveform is a downward convex waveform which is partially observed in frequency characteristics of the void-arranged structural body in a frequency range in which a ratio of a detected electromagnetic wave to an irradiated electromagnetic wave is relatively increased.

10. The method according to claim 6, wherein the at least one parameter is a change in a peak waveform generated in the frequency characteristics of the electromagnetic wave.

11. The method according to claim 10, wherein the electromagnetic wave is a back-scattered electromagnetic wave.

12. The method according to claim 10, wherein the peak waveform is an upward convex waveform which is partially observed in frequency characteristics of the void-arranged structural body in a frequency range in which a ratio of a detected electromagnetic wave to an irradiated electromagnetic wave is relatively decreased.

13. The method according to claim 1, wherein the electromagnetic wave is a forward-scattered electromagnetic wave.

14. The method according to claim 1, wherein the electromagnetic wave is a back-scattered electromagnetic wave.
